(19) United States
(12) Patent Application Publication
(10) Pub. No.: US 2009/0267372 A1
(43) Pub. Date: Oct. 29, 2009

(54) Tweezers with pivotal slidable illuminating device

(76) Inventor: Ming-Nan Chen, Taichung (TW)

Correspondence Address: BIRCH STEWART KOLASCH & BIRCH, PO BOX 747, FALLS CHURCH, VA, 22040-0747, US

(21) Appl. No.: 12/149,160

(22) Filed: Apr. 28, 2008

(51) Int. Cl. B25B 9/02

(52) U.S. Cl. 294/99.2

(57) ABSTRACT

A tweezer assembly for handling minute objects includes two prongs comprising a rear opening having an upward inclined proximal end, an arcuate, enlarged distal end, and an elongated straight portion; a fulcrum member integrally formed with the prongs and having a through hole; a handle comprising two half portions including a grooved rail with the prong secured thereto and a trough aligned with the opening, and an intermediate member having a projection inserting into the through hole to secure the handle and the fulcrum member together; and a lamp comprising two side projections having a peripheral groove and a flat on the groove. The lamp is adapted to slide by sliding the projections along the troughs. The sliding will be stopped when the grooves enter the proximal ends with the flats being inclined to engage the proximal ends so as to pivot the lamp.

### BACKGROUND OF THE INVENTION

1. Field of Invention

The invention relates to tweezers and more particularly to such a pair of tweezers having a battery powered lamp which is pivotable for adjusting the direction of light projected toward a minute object and also slidable for adjusting (i.e., decreasing) the distance between the tweezers and the desired minute object so that a user may clearly see the object.

2. Description of Related Art

Tweezers are known for applications such as gold panning, clockwork, surface mount electronics, stamp collecting, in cosmetics for plucking eyebrows, etc. A conventional type of tweezers without illuminating means is shown in FIG. 1. A portable illuminating device such as flashlight is required to provide a sufficient illumination toward a small object being worked by the tweezers if no fixed illuminating means is available. This means that a user has to hold the tweezers by one hand and hold the flashlight by the other hand in working. This is very inconvenient.

Another conventional type of tweezers 10 with illuminating means is shown in FIG. 2. The tweezers 10 comprises two prongs 14 having an inclined intermediate portion 13, a cylindrical receptacle 11 with internal threads provided at the fulcrum point extending a distance into a space defined by the prongs 14, and a battery powered lamp 12 threadedly mounted in the receptacle 11 with its switch being protruded for manual manipulation.

However, the well known illuminated tweezers suffer from several disadvantages. For example, the threading fastening of the lamp 12 in the receptacle 11 is not reliable, i.e., it may loosen after a short time of use. Further, the lamp 12 is fixed at the fulcrum point and this means that both an adjustment of the direction of light projected toward a minute object and an adjustment (i.e., decreasing) of the distance between the tweezers and the desired minute object are impossible.

There have been numerous suggestions in prior patents for illuminated tweezers. For example, U.S. Pat. Nos. 3,287,547 and 4,524,647 both disclose illuminated tweezers. Thus, continuing improvements in the exploitation of illuminated tweezers are constantly being sought.

### SUMMARY OF THE INVENTION

It is therefore one object of the invention to provide a pair of tweezers having a lamp which is pivotable for adjusting the direction of light projected toward a minute object and also slidable for adjusting the distance between the tweezers and the desired minute object so that a user may clearly see the object.

The above and other objects, features and advantages of the invention will become apparent from the following detailed description taken with the accompanying drawings.

### BRIEF DESCRIPTION OF THE DRAWINGS

FIG. 1 is a perspective view of a conventional tweezers;

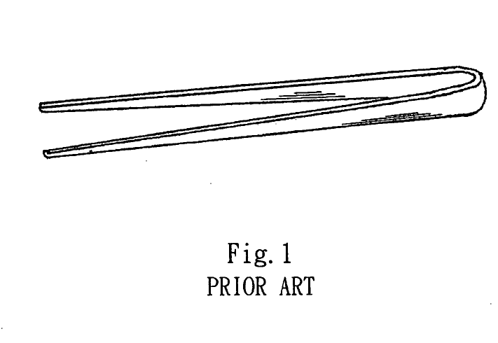

FIG. 2 is a perspective view of a conventional illuminated tweezers;

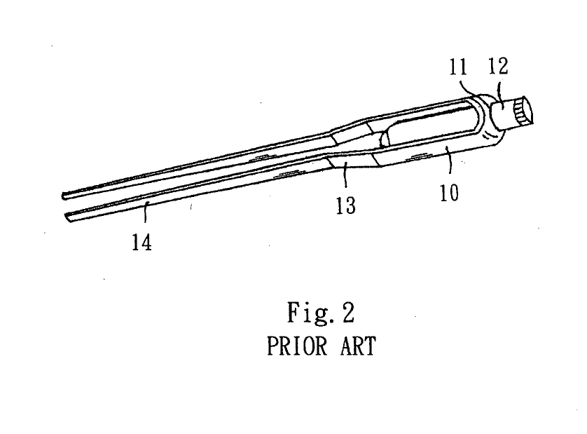

FIG. 3 is a perspective view of a first preferred embodiment of illuminated tweezers according to the invention;

FIG. 4 is a perspective view of a second preferred embodiment of illuminated tweezers according to the invention;

FIG. 5 is an exploded view of the tweezers of FIG. 4;

FIG. 6 is an exploded perspective view of the tweezers of FIG. 4;

FIG. 7 is a longitudinal sectional view of the tweezers of FIG. 4;

FIG. 8 is a view similar to FIG. 7 where the lamp is slid to the distal ends of the openings in the mounted position;

FIG. 9 is a view similar to FIG. 8 where the lamp is sliding to the intermediate positions of the openings; and

FIG. 10 is a view similar to FIG. 8 where the lamp is slid to the proximal ends of the openings and is inclined relative to the prongs due to pivoting.

### DETAILED DESCRIPTION OF THE INVENTION

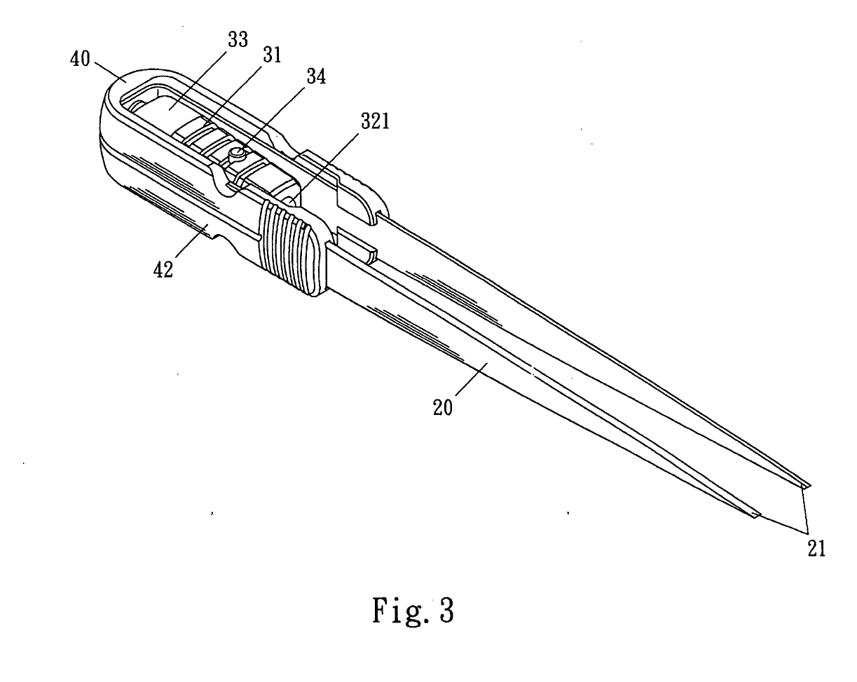

Referring to FIG. 3, an illuminated tweezers in accordance with a first preferred embodiment of the invention is shown. The characteristic of the prongs 20 of the first preferred embodiment is that the prongs 20 have a straight forward tip 21.

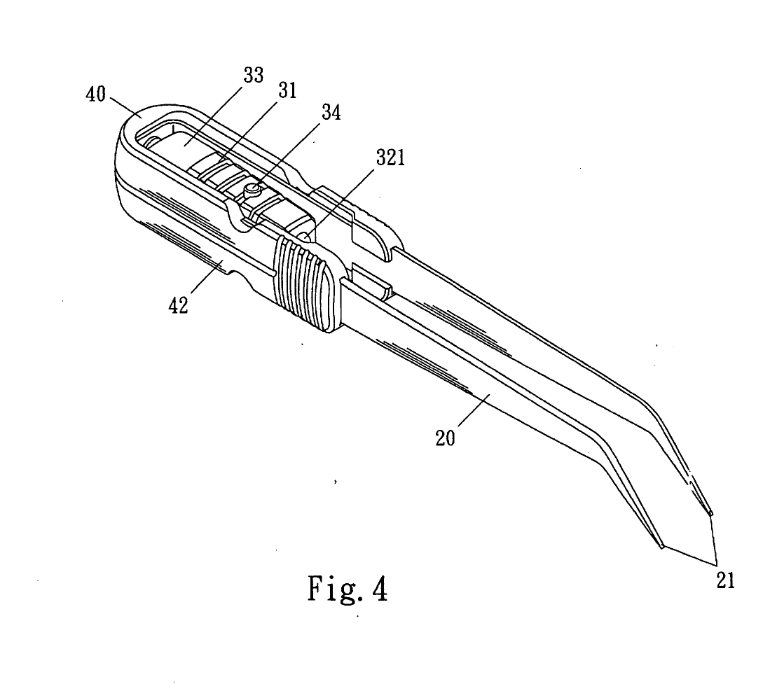

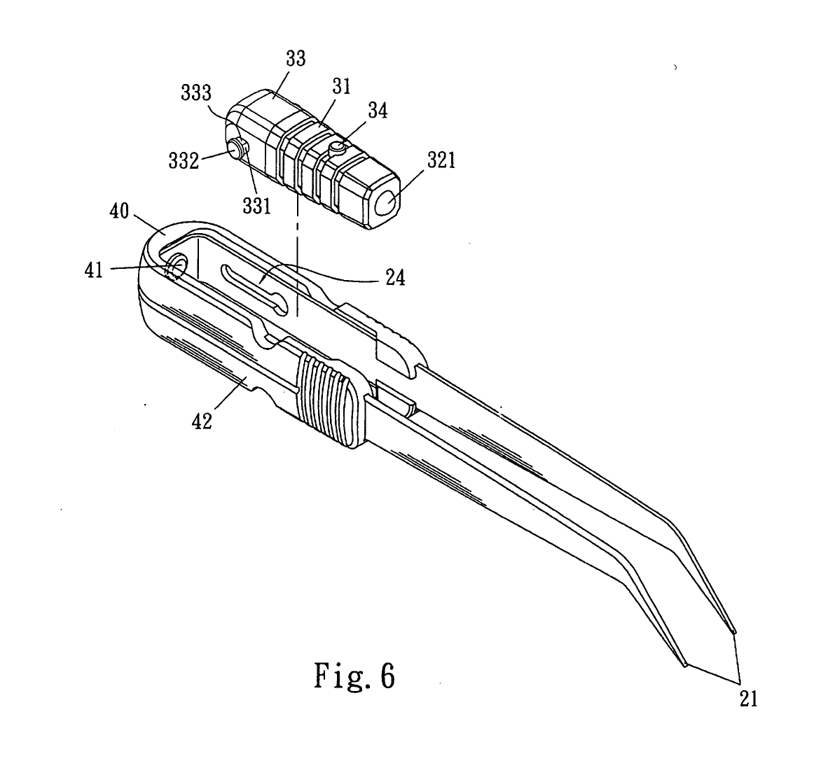

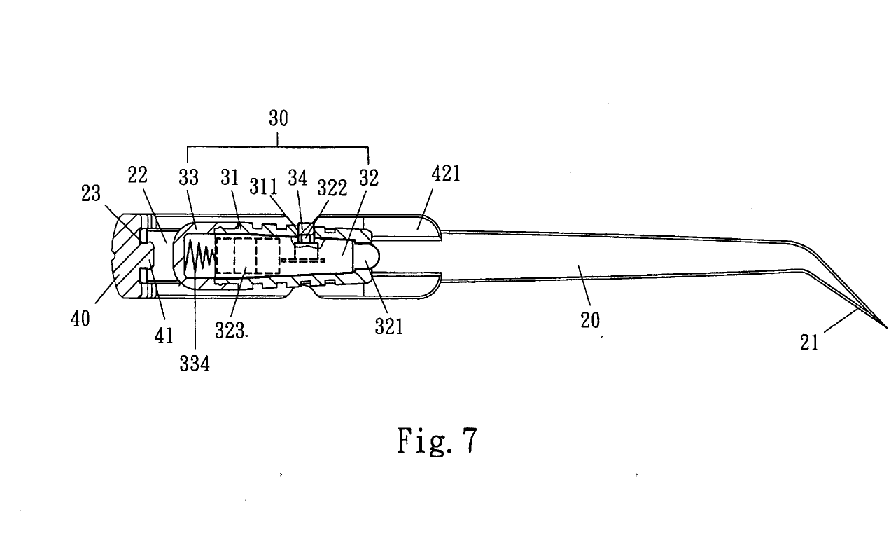

Referring to FIGS. 4 to 10, an illuminated tweezers in accordance with a second preferred embodiment of the invention is shown. The characteristic of the prongs 20 of the second preferred embodiment is that the prongs 20 have an inclined forward tip 21.

The integral tweezers comprises two identical prongs 20 formed of metal interconnected by a flat rear interconnection (i.e., fulcrum point) 22 to form a U. The interconnection 22 has a circular through hole 23. The prong 20 has an inclined forward tip 21, and a rear elongated opening 24 proximate the interconnection 22. The opening 24 comprises a slightly upward inclined proximal end 243, an arcuate distal end 241, and a straight portion 242 interconnecting both ends 241, 243 in which the distal end 241 has a diameter larger than height of the straight portion 242.

The tweezers further comprises an elongated flexible handle 40 of molded plastic. The handle 40 comprises two identical left and right portions 42 interconnected by an intermediate member (not numbered) having an arcuate outer surface, and a projection 41 having an enlarged head projecting from an inner surface of the intermediate member and being adapted to insert into the through hole 23 to secure the handle 40 and the prongs 20 together with the intermediate member of the handle 40 engaged with the interconnection 22. Either portion 42 has a grooved rail 421 of T-section extending from one open end to the intermediate member, and a rear trough 422 proximate the intermediate member formed on the flat portion of the rail 421. The troughs 422 are substantially aligned with the openings 24 when the left and right portions 42 are bent about the intermediate member of the handle 40 to fit rear portions of the prongs 20 in the rails 421.

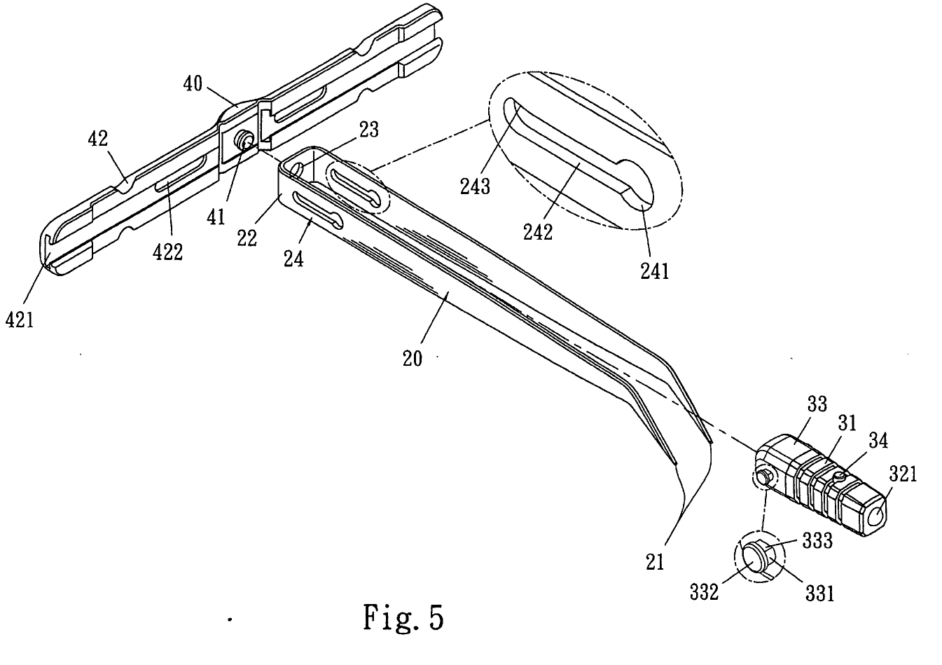

As shown in FIG. 5, the tweezers further comprises a lamp 30 of substantially parallelepiped. The lamp 30 comprises a rear casing 33 including a helical spring 334 formed of conductive metal and fastened on the bottom of an internal space, a projection 332 protruding out of either side surface, the projection 332 being peripherally grooved at 331, and the groove 331 having a top flat 333; a battery compartment 31 releasably secured to the casing 33 by snapping and including an opening 311; an electrical assembly 32 including one or more batteries 323 contained in the battery compartment 31, the batteries 323 being electrically connected to the spring 334, a switch 322 fitted in the opening 311 and electrically connected to the batteries 323, and a bulb 321 projecting out of the forward end of the case 31 and electrically interconnected the switch 322 and the spring 334; and a button 34 slidably mounted on the switch 322 and projecting out of the top surface of the battery compartment 31. Hence, pressing the button 34 will turn on the lamp 30 via the switch 322 and pressing the button 34 again will turn off the lamp 30 via the switch 322.

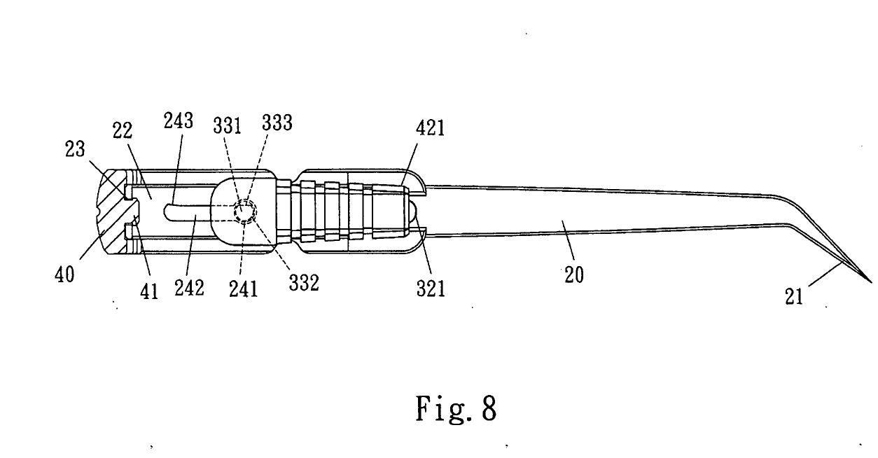

The projections 332 are inserted through the distal ends 241 into the troughs 422 with the grooves 331 disposed in the distal ends 241 after installing the lamp 30 (see FIG. 8). In this position, the lamp 30 is fastened. Also, light projected by the bulb 321 is in a direction substantially parallel to the prongs 20 and is adapted to clearly illuminate a minute object being worked for user viewing since the distance between the tweezers and the desired minute object is a minimum.

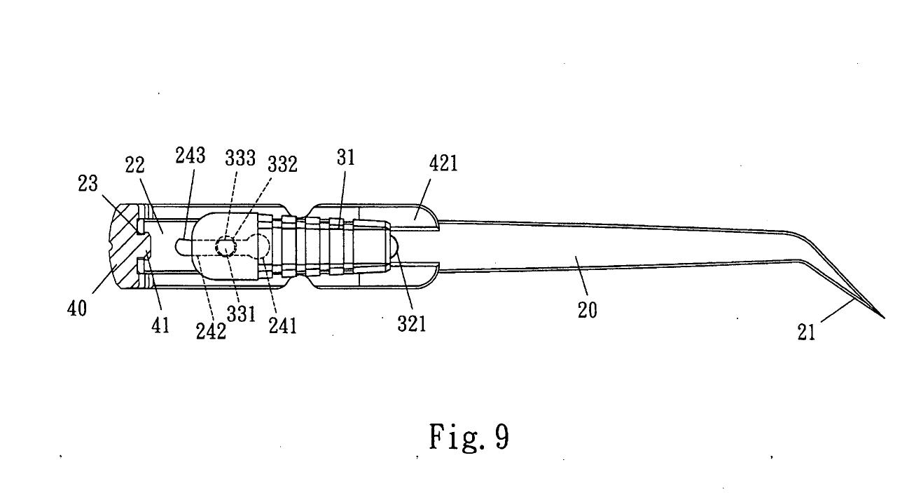

Advantageously as shown in FIG. 9, a user may push the lamp 30 rearward to cause the projections 332 to slide along the troughs 422 and cause the grooves 331 to slide along the straight portions 242 of the openings 24 for adjusting the distance between the tweezers and the desired minute object. Also, in this position the lamp 30 is fastened.

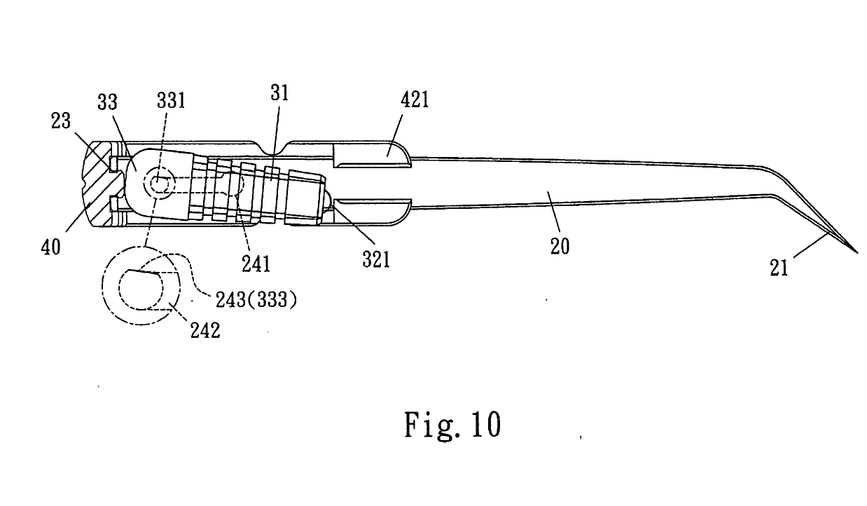

The sliding of the lamp 30 will be stopped when the projections 332 enter the proximal ends of the troughs 422 and the grooves 331 enter the proximal ends 243 with the flats 333 slightly inclined in the proximal ends 243 to engage with the upper edges of the proximal ends 243 due to pivoting (see FIG. 10). In this position, the lamp 30 is slightly inclined downward such that light projected by the bulb 321 will be at an acute angle with respect to the prongs 20. It is envisaged by the invention that the direction of the projecting light is directed toward the tips 21. This means that the lamp 30 is pivotal and hence the light 30 is capable of projecting light in a wider range.

While the invention herein disclosed has been described by means of specific embodiments, numerous modifications and variations could be made thereto by those skilled in the art without departing from the scope and spirit of the invention set forth in the claims.

What is claimed is:

1. A tweezer assembly comprising:
two prongs comprising a rear opening having an upward inclined proximal end, an arcuate distal end, and an elongated straight portion interconnecting both ends wherein the distal end has a diameter larger than the width of the straight portion;
a fulcrum member integrally formed with rear ends of the prongs, the fulcrum member having a through hole;
a handle comprising first and second half portions including a grooved rail on the inner surface with the prong secured thereto and a trough aligned with the opening, and an intermediate member having a projection inserting into the through hole to secure the handle and the fulcrum member together; and
a light source comprising a projection on either side surface, the projection having a peripheral groove and a flat on the groove;
wherein the projections are inserted through the distal ends into the troughs with the grooves disposed in the distal ends in a ready to use position;
wherein the light source is adapted to slide rearward by sliding the projections along the troughs and sliding the grooves along the straight portions for adjusting a distance between light source and an object being work; and
wherein the sliding of the light source will be stopped when the grooves enter the proximal ends with the flats being inclined to engage with the proximal ends so as to downward pivot the light source a predetermined angle.

2. The tweezer assembly of claim 1, wherein the light source is a battery powered lamp.

3. The tweezer assembly of claim 1, wherein the rails are of T-section.

4. The tweezer assembly of claim 1, wherein the handle is made of molded plastic.
